(19) United States
(12) Patent Application Publication
(10) Pub. No.: US 2008/0215381 A1
(43) Pub. Date: Sep. 4, 2008

(54) System and Method for Electronic Group Tour Reservation

(76) Inventor: Marc R. Reiter, Hooks, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/680,738

(22) Filed: Mar. 1, 2007

(51) Int. Cl. G06Q 10/00

(52) U.S. Cl. 705/5

(57) ABSTRACT

A method and system for an electronic group tour reservation allows reservation of several components of a tour for an entire group. The method includes receiving hotel reservation request from a user. The method includes receiving activities information from the user. The method includes placing queries to the network of hotels for rates and availabilities. The method includes placing queries to a plurality of activities providers for rates and availabilities. The method includes receiving hotel rates and availabilities from the hotels. The method includes receiving activities availabilities and rates from the activities provider. The method includes presenting hotel rates and availabilities and activities rates and availabilities to the user.

### FIELD OF THE INVENTION

The present invention relates generally to electronic commerce. In particular, the present invention relates to a system and method for electronic group tour reservation.

### BACKGROUND OF THE INVENTION

Many online reservation Web sites allow users to make reservations for hotels and activities. These Web sites typically allow a user to make reservations for one to two individuals. These Web sites generally do not allow a user to make reservation for hotels and activities for an entire group.

Generally when a student group or any other group wants to make a reservation for a tour, the group usually requires the assistance of a group tour operator. The group tour operator generally makes reservation for hotel and activities for the entire group. The group tour operator generally charges a fee to make the reservation for the entire group.

There is a need for an electronic group tour reservation system and method that allows a user to efficiently make reservation for hotels and activities for an entire group. There is a need for an electronic group tour reservation system and method that allows a user to make reservation for an entire group thus avoiding the need to pay a group tour operator.

### SUMMARY OF THE INVENTION

The invention is directed to a method and system for an electronic group tour reservation. In one aspect, the system includes a Web server, a hotel search application, an activities search application and a reservation application. The electronic group tour reservation system is connected to a network of hotels and activities providers through a wide area network such as the Internet. The electronic group tour system allows reservation of lodging and activities for the members of the group. A user may access the system by using a personal computer or any other computing device.

In one embodiment, the method includes receiving hotel reservation request from a user. The hotel reservation request includes destination, arrival and departure dates, number of members in the group, and group-type information. The method includes receiving activities information from the user. The activities information includes desired activities-type. The method includes placing queries to the network of hotels for rates and availabilities. The queries for hotel rates and availabilities are based on the hotel reservation request provided by the user. The method includes placing queries to a plurality of activities providers for rates and availabilities. The queries for activities are based on the activities information provided by the user. The method includes receiving hotel rates and availabilities from the hotels. The method includes receiving activities availabilities and rates from the activities provider. The method includes presenting hotel rates and availabilities and activities rates and availabilities to the user.

The method includes receiving a hotel booking request from the user. The hotel booking request indicates the user selected hotel based on a review of the hotel rates and availabilities presented to the user. The method includes receiving activities booking request from the user. The activities booking indicates the user selected activities based on a review of the activities availabilities and rates presented to the user. The method includes booking the hotel and the activities based on the hotel booking request and the activities booking request, and providing confirmation of the hotel and the activities to the user.

### BRIEF DESCRIPTION OF THE DRAWINGS

FIG. 1 is a logical flow diagram that generally illustrates several steps performed by the electronic group tour reservation system to receive hotel and activities reservation requests from a user and, in response to the requests, present hotel and activities rates and availabilities to the user.

FIG. 2 is a logical flow diagram that generally illustrates several steps performed by the electronic group tour reservation system to book the hotel and the activities based on the hotel booking request and the activities booking request from the user.

FIG. 3 is a logical flow diagram generally illustrating the steps performed by the user for booking a tour for a group with an electronic group tour reservation system.

FIG. 4 is a functional block diagram generally illustrating an electronic group tour reservation system in accordance with one embodiment of the invention.

FIGS. 5-7 are example screen displays that are provided to the user as the user interfaces with the reservation system.

### DETAILED DESCRIPTION OF THE DRAWINGS

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. These and other objects, features and advantages of the present invention will be more readily apparent when considered in connection with the following detailed description of embodiments of the invention, which description is presented in conjunction with annexed drawings below.

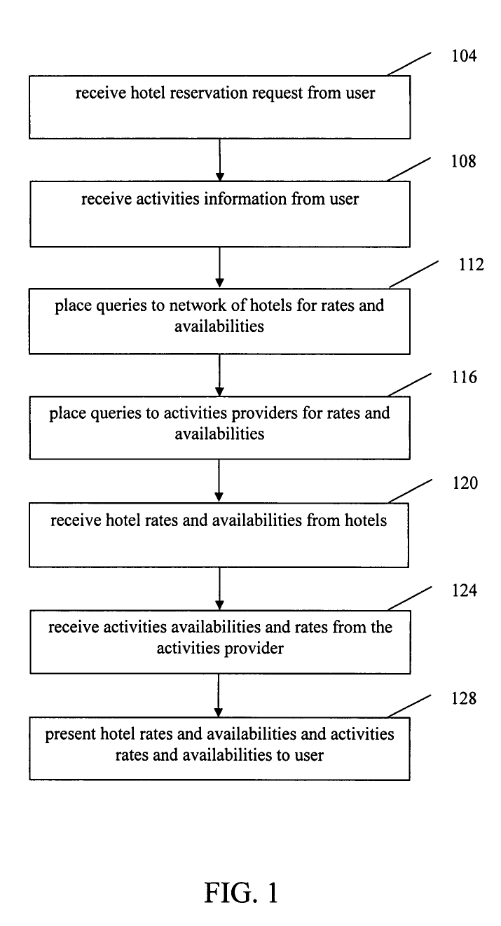

FIG. 1 is a logical flow diagram that generally illustrates several steps performed by the electronic group tour reservation system to receive hotel and activities reservation requests from a user and, in response to the requests, present hotel and activities rates and availabilities to the user. In step 104, the reservation system receives a hotel reservation request from the user. The hotel reservation request includes destination, departure and return dates, size of the group (i.e., number of individuals in the group), group-type and other relevant information. The destination information allows the reservation system to search for hotels in a specific destination. The departure and return dates allow the reservation system to search for availabilities in those dates. The travel dates allow the reservation system to set pricing schedules as rates vary by dates. The size of the groups also allows the reservation system to set pricing schedules as some hotels may provide discounts depending on the number of individuals in the group.

Some examples of group-types include a group attending a Disney Magic Music Days performance or festival, a sports event at Disney's Wide World of Sports, a Church Youth Group meeting, or a Disney Night of Joy Special performance. It will be understood by those skilled in the art that the group-type can be any type of group. The group-type information allows participating hotels and activities providers to determine whether they like to solicit such groups. For example, some hotels may not wish to book spring break or sporting event trips.

In step 108, the reservation system receives activities information from the user. The activities information includes one or more desired activities. Activities may include, for example, visiting the Universal Studios or attending an Arabian Nights show, a Planet Hollywood meal, or a sporting event.

In step 112, the reservation system places queries into a network of hotels for rates and availabilities. The queries for the hotel rates and availabilities are constructed based on the hotel reservation request provided by the user. In step 116, the reservation system places queries to a network of activities providers for rates and availabilities for various activities. The queries for the activities are based on the activities request provided by the user.

In step 120, the reservation system receives hotel rates and availabilities from the network of hotels. In step 124, the reservation system receives activities availabilities and rates from the network of activities provider. Thus, the reservation system is adapted to place queries to or receive from the network of hotels and the activities provider current availability and rate information. In one embodiment, information about the network of hotels and activities provider and the availability and the rate information is stored in a database. In step 128, the reservation system presents the hotel rates and availabilities and activities rates and availabilities to the user.

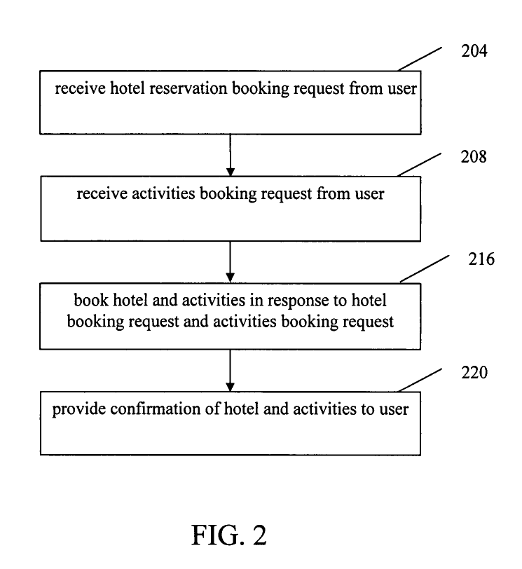

FIG. 2 is a logical flow diagram that generally illustrates several steps performed by the electronic group tour reservation system for booking the hotel and the activities based on the hotel booking request and the activities booking request from the user. As discussed above, the electronic reservation system receives hotel and activities reservation requests from the user and, in response to the requests, presents hotel and activities rates and availabilities to the user.

In step 204, the reservation system receives a hotel booking request from the user. The hotel booking request indicates the user selected hotel(s) based on a review of the hotel rates and availabilities presented to the user.

In step 208, the reservation system receives activities booking request from the user. The activities booking request indicates the user selected activities based on a review of the activities availabilities and rates presented to the user.

In step 212, the reservation system books the hotel and the activities based on the hotel booking request and the activities booking request. In step 216, the reservation system sends a confirmation of the hotel and activities to the user.

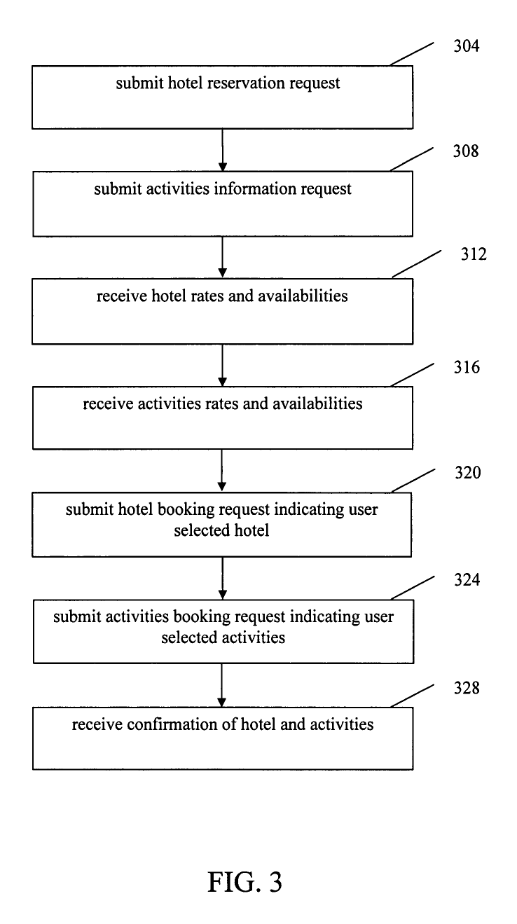

FIG. 3 is a logical flow diagram generally illustrating the steps performed by the user for booking a tour for a group with an electronic group tour reservation system. In step 304, the user submits a hotel reservation request to the electronic group tour reservation system. The hotel reservation request includes destination, arrival and departure dates, number of members in the group, and group-type. In step 308, the user submits activities information to the electronic group tour reservation system. The activities information includes desired activities-type.

In step 312, the user receives hotel rates and availabilities from the electronic group tour reservation system in response to the hotel reservation request and the activities information. In step 316, the user receives activities rates and availabilities from the electronic group tour reservation system in response to the activities information.

In step 320, the user submits a hotel booking request to the electronic group tour reservation system. The hotel booking request indicates the user selected hotel based on a review of the hotel rates and availabilities presented to the user.

In step 324, the user submits activities booking request to the electronic group tour reservation system. The activities booking request indicates the user selected activities based on a review of the activities availabilities and rates presented to the user.

In response to the hotel booking request and the activities booking request submitted by the user, the electronic group tour reservation system books the hotel and the activities. The system generates a confirmation of the hotel and the activities. In step 328, the user receives the confirmation of the hotel and the activities from the electronic group tour reservation system.

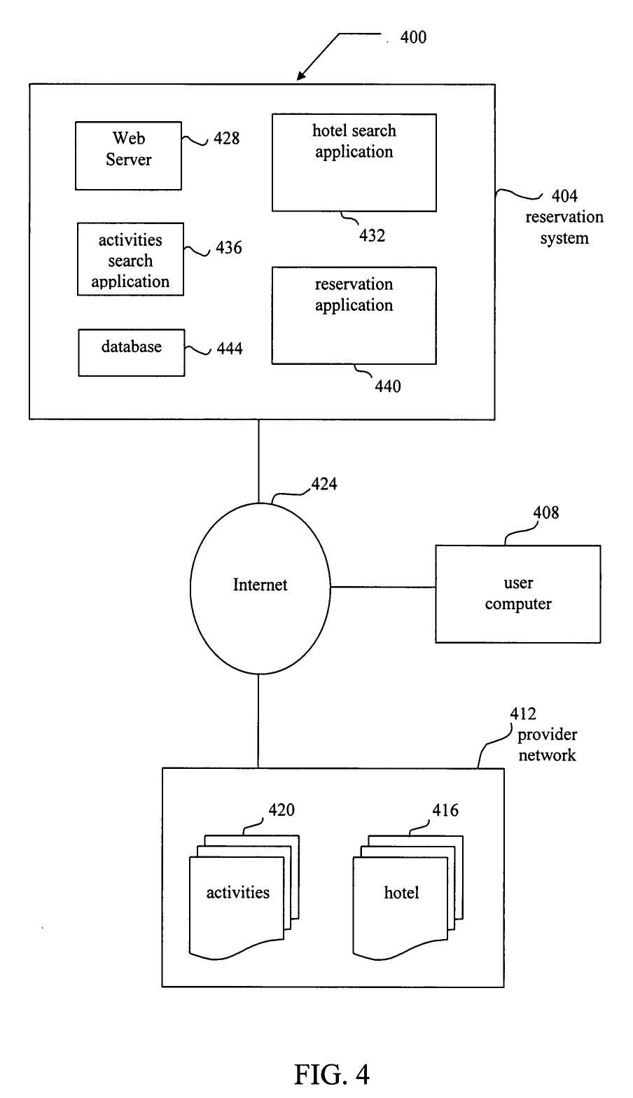

FIG. 4 is a functional block diagram generally illustrating an electronic group tour reservation system 400 in accordance with one embodiment of the invention. In one embodiment, the system is implemented as software modules running on a computer.

The system 400 includes a reservation system 404, a user computer 408, and a network of providers 412 such hotels 416 and activities providers 420. Each of these components may include one or more user computers like the user computer 408, and the components may be interconnected over a wide area network such as the Internet 424.

The reservation system 404 is adapted to receive requests from users via one or more user computers such the user computer 408. In response to the requests from the users, the reservation system 404 places queries to the network of hotels and activities providers 412.

The reservation system 404 further includes a Web server 428, a hotel search application 432, an activities search application 436, a reservation application 440, and a database 444. The Web server 428 controls an interface between the reservation system 404 and the user computer 408. The Web server 428 generates and serves Web pages over the Internet 424 to the user computer 408. The Web server 428 may also receive information provided by the user computer 408 through the Web pages. The Web server 428 makes the information received from the user computer 408 available to other components of the reservation system 404.

The hotel search application 432 is configured to access the hotels 416 in the network 412 and place queries to the hotels based on the requests from the user computer 408. The hotel search application 432 is configured to receive rates and availabilities information from the hotels 416. The hotel rates and availabilities are provided to the user computer 408 through the Web server 428.

The activities search application 432 is configured to access the network 412 and place queries to the activities providers 420 based on the requests from the user computer 408. The activities search application 432 is configured to receive rates and availabilities information from the activities providers 420, which are provided to the user computer 408 through the Web server 428.

The user is provided with an opportunity to review the rates and availabilities of hotels and activities, and based on the review the user makes booking requests to the reservation system 404 through the user computer 408. The booking requests are received by the Web server 428, which are provided to the reservation application 440. The reservation application 440 is configured to book the hotels and the activities in accordance with the booking requests made by the user. The reservation application 440 generates a confirmation of the reservation, which is provided to the user computer 408 through the Web server 428. The reservation system 404 also includes a database 444 configured to store information about the hotels and the activities providers in the network 412, and current rates and availabilities. The database 444 also stores reservation information including confirmation of reservations, cancellation, changes, etc.

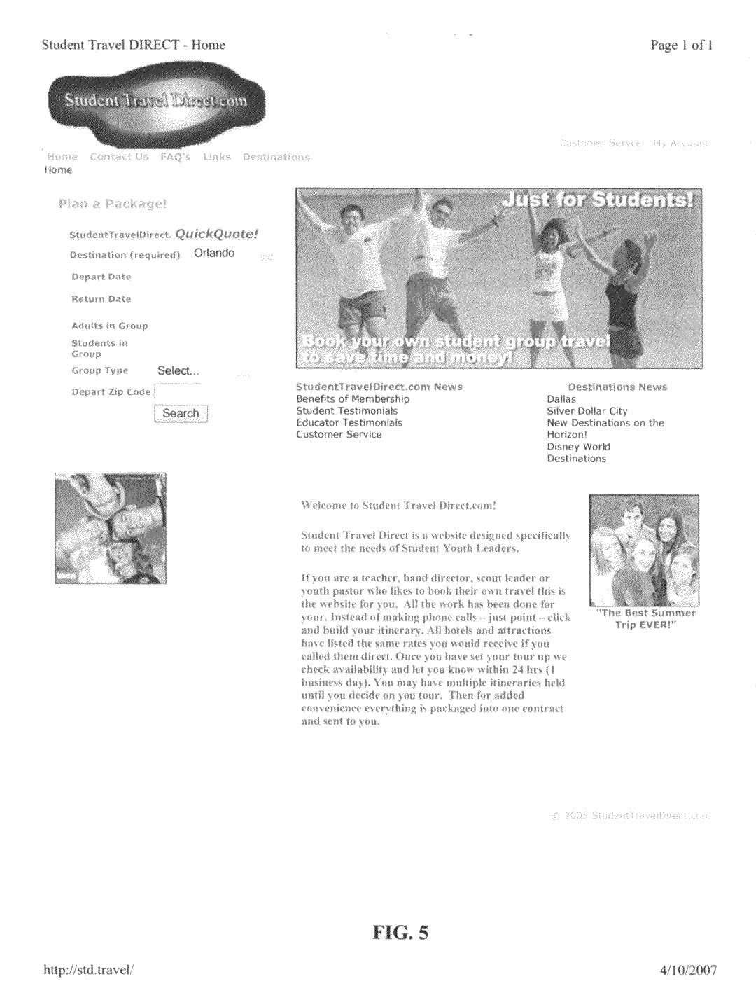

FIGS. 5-7 are example screen displays that are provided to the user computer 408 as the user interfaces with the reservation system 404. The screen displays are one or more Web pages served by the Web server 428.

FIG. 5 is an example screen display presented to a user by the Web server 428 to start the online group tour reservation process. The user is presented with various fields such as destination, departure date, return date, number of adults in group, number of students in group, group-type and departure zip code fields. In this implementation, the destination and group-type fields may be a drop-down menu that contains pre-selected destination and group-type names from which the user may select. The user activates the search button, which causes the information provided in the fields shown in FIG. 5 to be posted on the Web server 428. The Web server 428 provides the information to the hotel search application 432 and the activities search application 436 as discussed before.

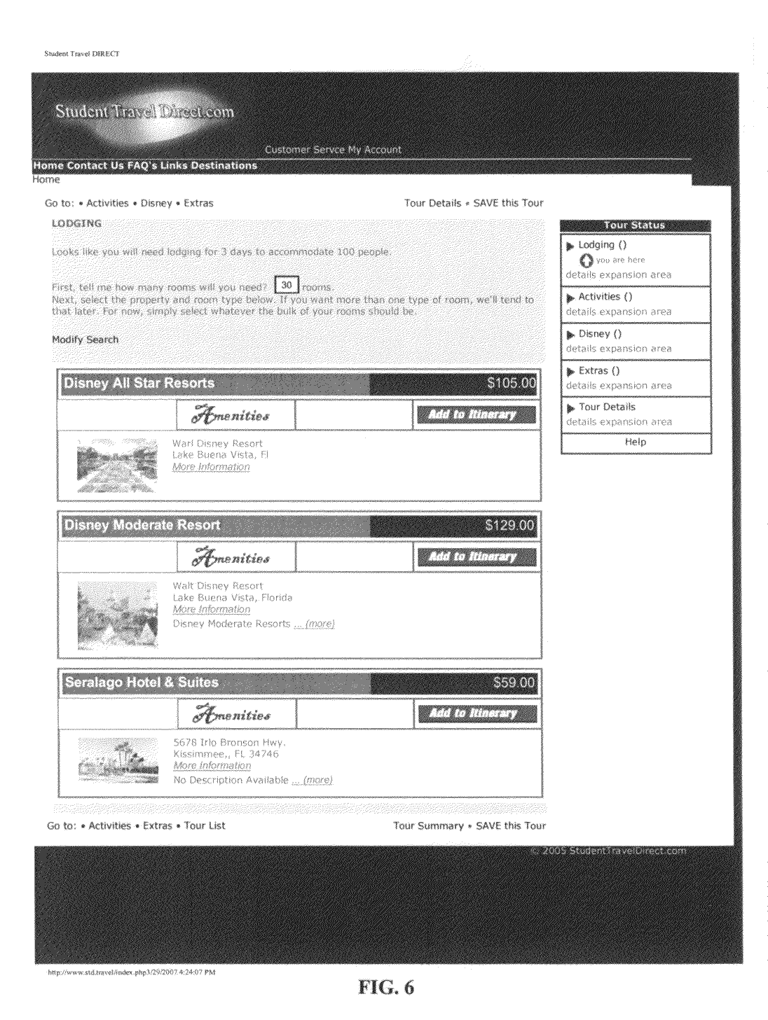

FIG. 6 is an example screen display presented to the user, which provides information about a plurality of hotels including names, addresses and rates. The hotels were selected from the network 412 in response to the information provided by the user. The user may select a hotel by activating the Add to Itinerary button.

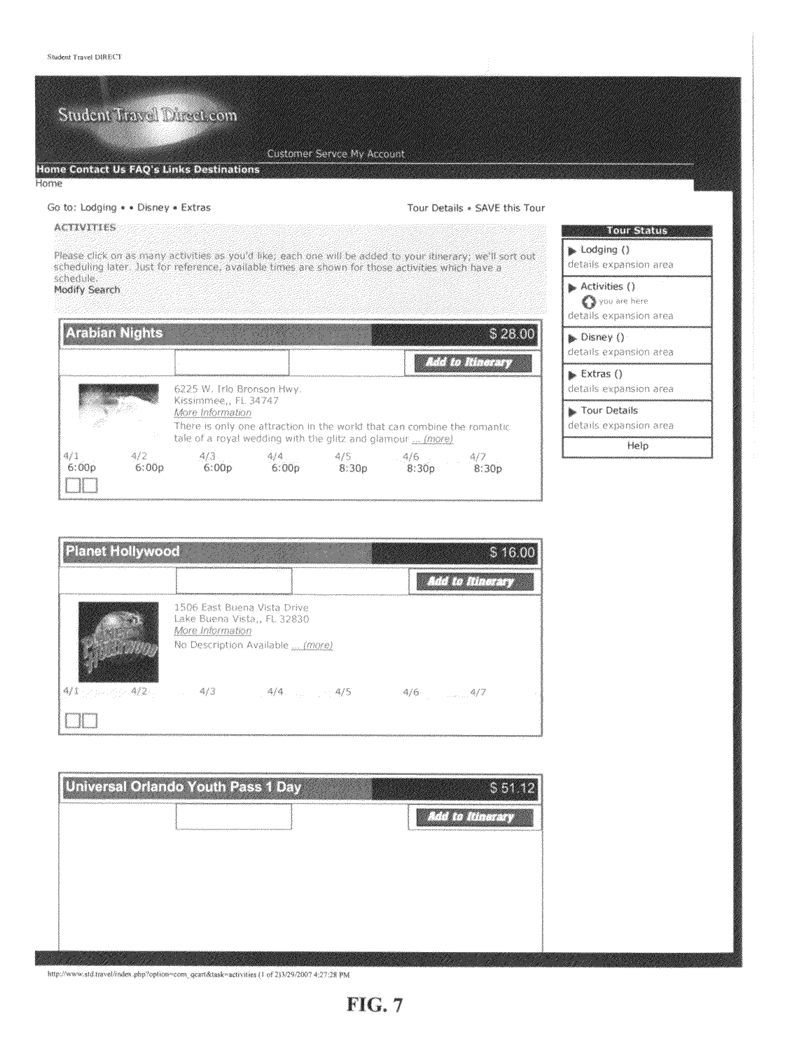

FIG. 7 is an example screen display presented to the user, which provides information about a plurality of activities including names, addresses, times, and rates. The activities were selected from the network 412 in response to the information provided by the user. The user may select one or more activities by activating the Add to Itinerary button.

Although the present invention and its advantages have been described in detail, it should be understood that various changes, substitutions and alterations can be made herein without departing from the spirit and scope of the invention as defined by the appended claims.

What is claimed is:

1. A method for booking a tour for a group with an electronic group tour reservation system, the electronic group tour reservation system including a web server, a hotel search application, an activities search application, a reservation application, the electronic group tour reservation system connected to a network of hotels and activities providers through the Internet, the electronic group tour system allowing reservation of lodging and activities for the members of the group, the method comprising the steps of:
receiving hotel reservation request from a user, the user being connected to the electronic group tour reservation system through the Internet, the hotel reservation request including destination, arrival and departure dates, number of members in the group, and group-type information;
receiving activities information from the user, the activities information including desired activities-type;
placing queries to the network of hotels for rates and availabilities, the queries for hotel rates and availabilities based on the hotel reservation request provided by the user;
placing queries to a plurality of activities providers for rates and availabilities, the queries for activities based on the activities information provided by the user;
receiving hotel rates and availabilities from the hotels;
receiving activities availabilities and rates from the activities provider; and
presenting hotel rates and availabilities and activities rates and availabilities to the user.

2. The method of claim 1, further comprising:
receiving a hotel booking request from the user, the hotel booking request indicating the user selected hotel based on a review of the hotel rates and availabilities presented to the user; and
receiving activities booking request from the user, the activities booking indicating the user selected activities based on a review of the activities availabilities and rates presented to the user.

3. The method of claim 2, further comprising:
booking the hotel and the activities based on the hotel booking request and the activities booking request; and
providing confirmation of the hotel and the activities to the user.

4. The method of claim 1, wherein the group-type is a spring-break tour group.

5. The method of claim 1, wherein the group-type is an educational tour group.

6. The method of claim 1, wherein the group-type is a religious tour group.

7. A method for booking a tour for a group with an electronic group tour reservation system, the electronic group tour reservation system including a web server, a hotel search application, an activities search application, a reservation application, the electronic group tour reservation system connected to a network of hotels and activities providers through the Internet, the electronic group tour system allowing reservation of lodging and activities for the members of the group, the method comprising the steps of:
submitting a hotel reservation request to the electronic group tour reservation system, the hotel reservation request including destination, arrival and departure dates, number of members in the group, and group-type;
submitting activities information to the electronic group tour reservation system, the activities information including desired activities-type;
receiving hotel rates and availabilities from the electronic group tour reservation system in response to the hotel reservation request;
receiving activities availabilities and rates from the electronic group tour reservation system in response to the activities information;
submitting a hotel booking request to the electronic group tour reservation system, the hotel booking request indicating the user selected hotel based on a review of the hotel rates and availabilities presented to the user;
submitting activities booking request to the electronic group tour reservation system, the activities booking request indicating the user selected activities based on a review of the activities availabilities and rates presented to the user; and
receiving a confirmation of the hotel and the activities from the electronic group tour reservation system.

8. The method of claim 7, wherein the group-type is a spring-break tour group.

9. The method of claim 7, wherein the group-type is an educational tour group.

10. The method of claim 7, wherein the group-type is a religious tour group.

11. An electronic group tour reservation system for booking a tour for a group, comprising:
a Web server configured to assemble and serve Web pages over the Internet to a user and configured to receive information provided by the user through the Web pages;
a hotel search application configured to access a hotel network based on a hotel reservation request submitted by the user through the Web pages, the hotel search application configured to identify potential hotels within the network based on the hotel reservation request, the hotel reservation request including destination, arrival and departure dates, number of members in the group, and group-type;
an activities search application configured to access a network of activities provider based on activities request submitted by the user through the Web pages, the activities search application configured to identify potential activities based on the activities request, the activities request including desired activities-type; and
a reservation application coupled to the hotel search application and the activities search application, the reservation application adapted to facilitate reservation by placing queries to and receiving from the hotels in the hotel network and the activities providers current availability and rate information, the reservation application providing the current availability and rate information to the hotel search application and the activities search application, the reservation application configured to make reservation in response to the user selected hotels and activities.

12. The electronic group tour reservation system of claim 11, further comprising a database configured to store hotel rates and availabilities information.

13. The electronic group tour reservation system of claim 12, wherein the database is configured to store activities rates and availabilities information.

14. The electronic group tour reservation system of claim 11, wherein the user accesses the system through a computer.

15. The electronic group tour reservation system of claim 11, wherein the group-type is a spring-break tour group.

16. The electronic group tour reservation system of claim 11, wherein the group-type is an educational tour group.

17. The electronic group tour reservation system of claim 11, wherein the group-type is a religious tour group.
